(19) United States
(12) Patent Application Publication
(10) Pub. No.: US 2009/0312885 A1
(43) Pub. Date: Dec. 17, 2009

(54) Management system for drilling rig power supply and storage system

(76) Inventor: Edward R. Buiel, Poland, OH (US)

Correspondence Address: Robert C. Curfiss, 19826 Sundance Drive, Humble, TX, 77346-1402, US

(21) Appl. No.: 12/157,571

(22) Filed: Jun. 11, 2008

(51) Int. Cl. G06F 1/28; H02J 4/00

(52) U.S. Cl. 700/297; 307/19

(57) ABSTRACT

Management control system for managing an energy supply and storage system for a rig power supply of the type having a power generator coupled to rig loads, the power generator used for powering the rig and for charging the storage system, and the storage system adapted for selectively supplementing rig power, is adapted for controlling the selection of rig function operation, for setting the system to recommended settings for the selected rig function operation, for monitoring rig power usage for the selected rig function operation for distributing excess power to the storage system when the rig power usage falls below a preselected threshold, and for distributing stored power from the storage system when the rig power usage is above a preselected threshold. The recommended setting for the selected rig function may be modified depending upon power usage by setting preselected thresholds.

### BACKGROUND OF THE INVENTION

1. Field of the Invention

The present invention is generally related to a management system for power supplies for drilling rigs and is specifically directed to an apparatus and a method for managing the conversion of chemical energy to electrical energy and for improving the energy efficiency of the rig through management of regeneration and improved power factors.

2. Description of the Prior Art

In the petroleum exploration industry the equipment used to bore wells for oil and gas recovery is commonly known as a drilling rig. Over the years, various types of rigs have been used by the industry and have been classified either by reference to the type of power used on board the rig to provide the motive force necessary to turn the drill bit or perform the other rig operations or as to the type of terrain on which the rig is situated. For example, a rig may be termed an “offshore” rig if it is one used for offshore drilling, but more commonly rigs are referred to as mechanical, DC/DC “Ward-Leonard” or AC/DC (SCR type), or VFD drive rig (AC-DC-AC) for the most modern rigs depending upon the type of power coupling used to provide motive force for the drilling operations, specifically, the type of power coupling used to provide the hoisting, hydraulic and rotational force for the drilling bit.

Recent advances in drilling rig efficiency have focused on increasing the boring rate. Key technological advancements in better bit design, more powerful rigs, and increased hydraulic horsepower have resulted in requiring fewer days to drill holes of any given depth. This is particularly important under current conditions wherein the rig operating efficiency is measured in drilled feet per gallon of diesel fuel burned and the price of fuel is at an all time high. Hydraulic Horsepower is the horsepower dedicated to mud pumps which pump mud at high pressure down the drill string to the bit and then return it up the well bore to surface. The typical utilized average hydraulic horsepower on a rig has undergone significant increase in recent years. This has resulted in a significant increase in the overall rig fuel consumption rate. As such the need for conservation of energy utilized and improved power management will become critical to remain competitive in the market place.

Over the last few decades, SCR and VFD rigs have become much more common and DC/DC and mechanical rigs are becoming scarce. The SCR and VFD rigs use a pool of diesel engine driven AC generators, or gensets, to produce alternating current power to a rig bus, from which AC motors, or DC motors via an AC to DC power converter (Silicon Controlled Rectifier) are used to perform various rig operations, including by way of example, running mud pumps, driving the drilling bit and lifting the drill string.

Typical operation of the rig results in a highly dynamic power consumption profile that leads to inefficiency. Specifically, the rig power source has to be prepared to provide maximum power on demand and this means that during periods of low power consumption the rig power source is producing or has the capacity to produce more power than is required, making the operation inefficient. This is because the size of the gensets is sufficient to operate in a manner to produce full power during periods of high demand. In addition, the typical rig is configured to operate in a failsafe manner such that failure of a portion of the gensets will not shut down the rig or prevent a critical operation from taking place requiring instantaneous incremental rig power from the generators online. This is critical because anytime a rig operation is shut down it is possible that the well will be lost. At a minimum, hours to days of drilling time may be lost. Under current practices it is necessary to further oversize the gensets on SCR rigs in order to compensate for the poor/lagging power factor.

The typical genset configuration results in power factor inefficiencies which are roughly equal to the ratio of the actual output to the full voltage output capability. This results in higher fuel consumption by running the engine (typically a diesel engine) at a lower than optimum efficiency. In addition, many of the operational motors such as the mud pumps typically operate at high pressure (and high current) and speeds lower than rated. It is not uncommon to operate at power factors of 0.4 to 0.5 lagging. Also, during periods of transient loads, it is not possible for the generation of power from the gensets to match the dynamic load of the operational equipment and dramatic power factor inefficiencies occur during the period required by the gensets to compensate for the changing load. Finally, the energy of the lowering string is typically dissipated in an auxiliary electric brake, water brake, mechanical brake pads and/or a braking resistor.

One of the advantages of the subject invention is that gensets having different ratings may be combined in order to further increase the efficiency of the operation. This means if a full genset capacity when all gensets are equal will result in overpowering the system, some gensets may have a lower capacity and by managing the system in accordance with the invention, the selected gensets can meet a specified power criteria without overpowering or under powering the rig operation. The primary control of the number of operating gensets is the state of the energy storage device. Typically, adding an energy storage device to the rig permits control of the operating gensets bases on the state of the stored charge.

In summary, in order to maintain full operational capability of the rig, the power capacity must greatly exceed the need during low consumption in order to assure full power on an as needed basis. In addition, the power capacity must be sufficient to continue operation of the rig in the event of partial failure of the power source. Without such contingencies any shut down of the rig or lack of instantaneous incremental power can result in costly or potentially catastrophic consequences.

Generally speaking, the prior art has attempted to solve the problem presented during peak demand operations due to poor power factors in one of three ways:
1. The two motors driving mud pumps were connected in series to limit the current demand placed upon the power generation system. This solution was obviously not effective on single motor mud pumps, or when as commonly occurred, pumps had to be run at a greater than 50% speed to produce the required volume. Furthermore, even if pumps were placed in series, it was still necessary to provide additional engine-gensets to provide KVAR for the draw works during tripping operations or when making additional connections.
2. Banks of capacitors were installed on the rig bus to supply a fixed amount of leading KVAR. This attempted solution also had several disadvantages. At low loads, the corrected power factor could be as poor leading as a result of the added KVAR as it was lagging without the compensation by the capacitors. Because the available power factor compensation was voltage dependent, and an increased KVAR demand (low voltage) was not met by an increased capability to compensate the power factor, voltage regulation was adversely affected. Furthermore, system short circuit current was significantly increased, often beyond the original rig design limits, and the introduction of capacitance gave the system both sub-synchronous and super-synchronous resonant frequencies not easily calculated but within the range of excitation by the SCR drive system, thereby creating potential system stability problems.
3. The rig generators were oversized, such that it was not uncommon to find 1500 KVA generators on 850 KW engines. Even this solution was not often sufficient and was expensive when done for all engine-generator sets. Aside from the higher initial capital expense required to provide oversize generators, the operation of oversized lightly loaded generators was inherently inefficient.
4. A power factor controller was provided for AD/DC drilling rigs and utilized a controlled, unloaded, over-excited generator to provide reactive power to maintain the rig power factor within acceptable limits during peak demand operations, see for example, U.S. Pat. No. 4,590,416, entitled: “CLOSED LOOP POWER FACTOR CONTROL FOR POWER SUPPLY SYSTEMS,” issued to Michael N. Porche, et al, on May 20, 1986.

While each of these approaches worked toward assuring the availability of power during peak periods, each was deficient in that it either did not greatly reduce the inefficiency of the system or was inherently unstable. Both conditions are detrimental to the safe and efficient operation of the rig.

### SUMMARY OF THE INVENTION

The subject invention incorporates an electrical energy storage component in the rig power supply system which may be used to capture energy typically dissipated by an auxiliary electric brake, water brake, mechanical brake pads and/or a braking resistor, provide a means for actively controlling the power factor, and provide a means to perform peak shaving, i.e., to provide power during periods of high dynamic load and capture additional energy from rig generators to recharge the energy store during periods where additional power is available due to reduced rig load demands. This allows the electrical generator units to be more correctly sized to the average power load and capture additional energy from rig generators to recharge the energy store during periods where additional power is available due to reduced rig demands. This also allows for much more efficient control of the generators while at the same time ensuring that sudden requirements for high power beyond the operating limits of the currently activated generators can be reliably met during unforeseeable periods of peak demand.

The system of the subject invention is adapted for providing instantaneous power to match the load requirements, for providing continuous power factor correction to ensure near-unity operation, for capturing energy typically dissipated by the an auxiliary electric brake, water brake, mechanical brake pads and/or a braking resistor and for allowing the engine-generators to be more accurately matched to the average load of the drilling rig while running continuously at a more efficient level of operation.

The crux of the invention is the management of engine generator sets (gensets) on line at any given time to support rig operations, providing active power factor correction and energy storage device that is directly connected to the AC bus. The device stores energy when surplus power is available from the gensets and regenerative braking system, rather than dissipating it by the braking resistor, and provides source power during periods of peak demand and power factor correction.

It is an important feature of the invention that the system provided herein permits the reduction of the number of operating gensets on the rig. In practice, rigs have different numbers of generators typically 2 to 6. In some cases, less than all generators are in simultaneous operation. In other cases all generators may be run. This may be needed in periods of peak demand when the battery is at a low state of charge. That is, the present invention may actually increase the demand on the generators rather than reduce it. Specifically, the configurations of the present invention permit the generators to run at a higher state of efficiency. This is because the need for over capacity is reduced or eliminated by the peak shaving function of the power conditioner and energy storage device. Excess power is stored in the energy storage device during periods of off-peak demand and then used during periods of peak demand. Generators can then be started and stopped over longer time intervals to provide the average power requirement of the rig and the state of charge of the energy storage device.

In the past, the additional capacity was needed and had to be continuously operating because of the lag time in bringing up an additional genset from a dormant or an off condition. The storage/source system of the subject invention provides additional power on demand, eliminating the need to have ready reserve generating capacity. This not only provides a consistent source of power on demand but eliminates the costs associated with supplying and supporting the additional genset and the associated increase in fuel required to operate the same. With this feature, the additional costs of incorporating the system of the subject invention in a rig power supply is greatly neutralized by the cost savings associated with the reduction in the number of operating gensets. By way of example, if two gensets are operating at 40% using prior art systems versus one genset operating at 80% using the configuration of the subject invention, the fuel usage is much higher because the generator efficiency decreases at lower loading. Typically, 80% load is near optimum efficiency.

Overall engine generators maintenance cost will be reduced by the use of invention. Typical engine generator service and maintenance costs are in the $2-4 per hour for each engine generator. This made up of oil consumption, oil and filter changes, AC generator overhaul, engine top jobs and major overhaul costs. Due to the engines generator system being run at higher average loads and in a more efficient manner the overall the result will be a significant reduction in the over all cost ownership of the rig engine generator package. In addition, the fact that much of the time you will be running one less engine generator than normal will provide even more significant savings.

It is also an important feature of the invention that the genset system can be configured to operate at or near maximum efficiency by selecting gensets that operate at highest efficiency during rig average load conditions. Since the rig power requirements are at both below average and above average much of the time, the prior systems required the gensets to have the capacity to operate at maximum requirements. The storage/source system of the subject permits the gensets to be configured to operate at or near maximum efficiency based on average load conditions. During periods of low loading the generated power is stored. During periods of high use, or sudden increase in demand, the stored power is withdrawn.

In its simplest form management system for the storage/source system of the subject invention comprises the means and method for controlling the power supply and power conditioner which is placed in the position of the braking resistor in a genset power supply system. The management system of the subject invention also controls the energy storage device, such as a bank of lead acid batteries, or the like, is in communication with the power supply and power conditioner and receives and stores energy when excess power is generated during periods of below average requirements. The storage device then provides a source of power through the power supply and power conditioner whenever the power demands exceeds the average level. This system greatly enhances the efficiency of the rig power system.

The crux of the subject invention is a system controller for automatically starting/stopping the generators based either historic load conditions or actual real-time load conditions for determining when to pull power from the batteries and when to store energy in the batteries.

Other advantages and features of the invention will be readily apparent from the accompanying drawings and description.

### DESCRIPTION OF THE DRAWINGS

FIG. 1 is an example of a typical management screen for the controller and management system of the subject invention, showing operation when the energy storage devices are in a charging mode.

FIG. 2 is similar to FIG. 1, showing operation when the energy storage devices are in a discharging mode.

FIG. 3 is a flow diagram for the system of the subject invention.

FIG. 4 is a first configuration of a rig power system in accordance with the subject invention for a rig with AC drives with a common DC bus.

FIG. 5 is a system controller configuration for a rig system having AC drives with a common DC bus, such as that shown in FIG. 4.

### DESCRIPTION OF THE PREFERRED EMBODIMENT

The subject invention comprises a method for managing an energy supply and storage system for a rig power supply of the type having a power generator coupled to rig loads, the power generator used for powering the rig and for charging the storage system, and the storage system adapted for selectively supplementing rig power, the method comprising the steps of: selecting a rig function operation; setting the system to recommended settings for the selected rig function operation; monitoring rig power usage for the selected rig function operation; distributing excess power to the storage system when the rig power usage falls below a preselected threshold; and distributing stored power from the storage system when the rig power usage is above a preselected threshold. In the preferred embodiment the recommended setting for the selected rig function may be modified depending upon power usage by setting preselected thresholds.

Typically, the rig includes a plurality of engines for providing power to the rig, wherein the setting step comprises the step of activating and running selected engines. The system may respond automatically depending upon the rig operation function or may be activated manually.

In the preferred embodiment the energy supply and storage system comprises a power supply in parallel with the rig motors and adapted for receiving energy generated by the generator in excess of demand and an energy storage system in communication with the power supply for receiving and storing the excess energy, the power supply being adapted to draw energy from the storage system when the rig motor demand exceeds the capacity of the generator.

Where desired, means are provided for conditioning the energy stored in and withdrawn from the energy storage system.

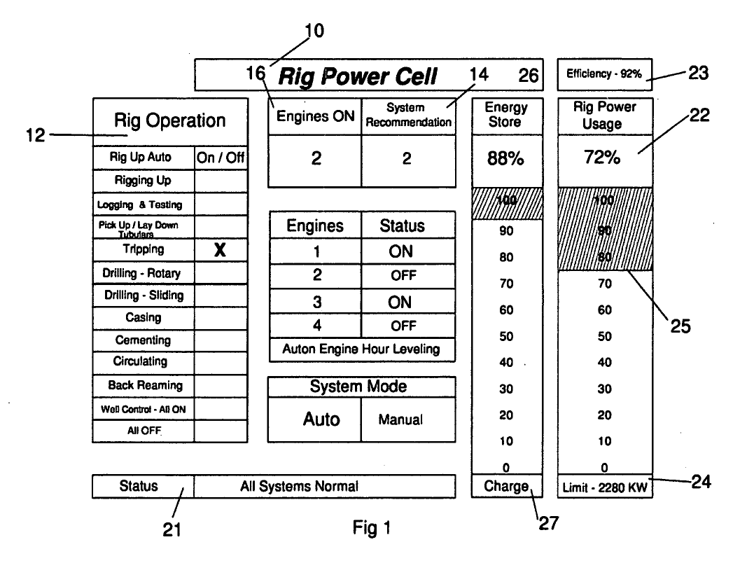

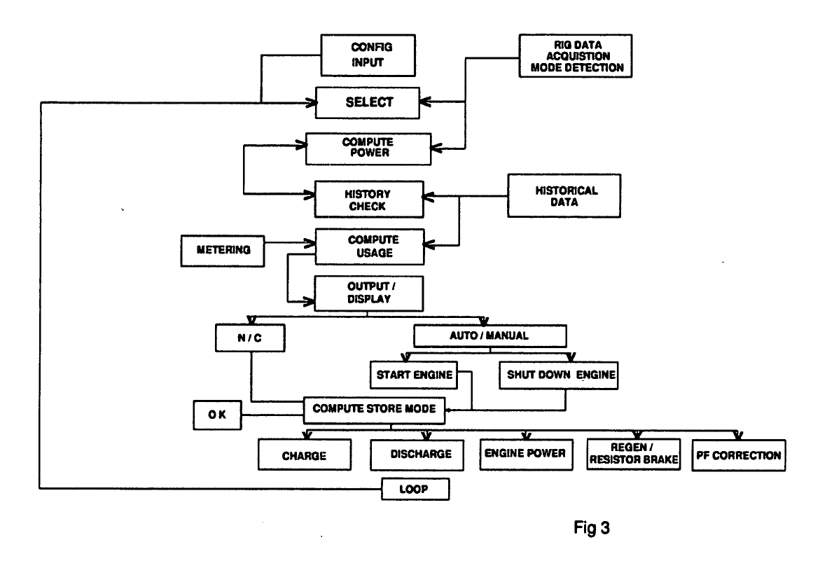

As shown in FIG. 1, an operator screen 10 will be provided for managing and operating the power supply/storage system of the rig. Each of the operating functions of the rig is listed in a table 12. This is typically an informational table, and will provide an “X” next to the function in current operation, e.g., “Tripping”. During the Tripping operation two of the four rig engines are recommended, see box 14. This will automatically be displayed in box 14 whenever the rig is in Tripping operation. As indicated at box 16, in the example two of the four engines are “ON” or operating, as recommended. An Engine Status box 18 will indicate the status of the engines. In the example the rig has four engines and engines “1” and “3” are on while engines “2” and “4” are off. The management controller can deduce by analyzing drilling patterns the mode of operation. The controller is provided with additional rig operational real time data such as hookload, block position, torques, Mud Pump stroke rates, Mud Pump pressures, and the like. This mode of operation is selected via the “Auto Determine Operation” button as indicated by the AUTO/MAN on FIG. 3 and as indicated at the System Mode box 20 on FIG. 1.

As indicated at the System Mode box 20, this example indicates a system in AUTO mode. This means that when a specific rig operation is selected, the management system automatically sets the number of engines operating in accordance with the system recommendations. A manual override is also provided, giving operator control where desired. Since the rig in the example is operating as recommended the status is indicated as normal, as displayed in Status box 21.

Rig power usage is indicated in the Rig Power Usage box 22. In the example of FIG. 1, the efficiency of the power usage is measured and displayed at 92%, see box 23. The total capacity is shown at the Limit box 24. In the shown operation, 72% of the available power is being used to drive the rig during Tripping as indicated at point 25 in the Rig Power Usage box 22. This means 28% of the available power may be distributed, in this case to the energy storage devices, as indicated by the Energy Store box 26, see “CHARGE” indicator 27. Since the energy storage devices are below 100% capacity, as indicated at point 28, they may be charged with the excess available power.

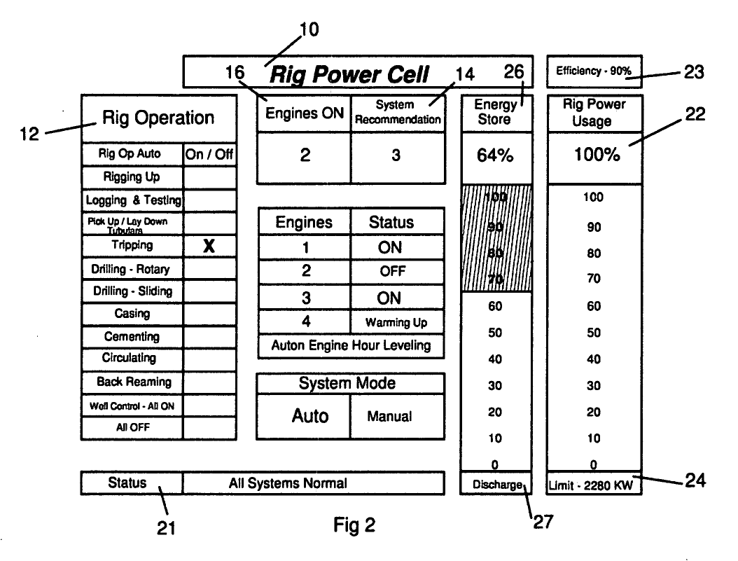

Under certain periods during the Tripping function, the Power Usage may exceed the limit of the two engines. This condition is shown in FIG. 2. In such a condition, the system the incorporation of an additional engine, in the case three, as shown in System Recommendation box 14. This will occur on short or no notice so an engine will begin warming up, see engine “4” in the Engine Status box 18. However, during warm up the two operating engines will not produce enough power to meet rig demand. In this case, power is discharged from the energy storage devices as indicated by the “Discharge” indicator in the Energy Store box 26. This will draw down the stored energy until the third engine is warmed up and in operating mode. At that time, the three engines will provide sufficient power to operate the rig and any excess power generated will be distributed to the energy storage devices. This permits additional engines to be utilized on an as needed basis, greatly increasing the efficiency of the rig, as well as permitting excess power to be distributed to the storage devices rather than dissipated.

The flow chart for the controller management system is shown in FIG. 3. In the preferred embodiment, the proposed energy management controller system comprises a computerized control model that contains the following elements to compute what forecast energy requirements maybe and then accurately react to this forecast based on historical and current energy requirements:
AC Power Load list: List of all potential sources of load on the drilling rig.
DC Power Load list: List of all potential sources of load on the drilling rig.
Matrix of typical AC & DC loads engaged for a given rig operation and to what % of full load they may be in use for same.
Rig Generators and capacities.
Energy Store capacity and current status.
Current rig operation.
Future rig operation.
Bit Depth.
Hole Size.
Input from historical database of rig power consumption for similar operation.
Other drilling and system parameters and measures as deemed necessary to effect an optimal model to control the system energy store and deliver element.

An Energy Management Controller System Data model analyzes the rig operation and current rig equipment configuration to estimate the power requirements and the appropriate # of engines required at any given time—Additional drilling modes may be added as needed, typical modes as examples are shown. The analysis may adjust for bit depth, drilling operations and also self learns based on historical data. If the rig personnel do not input the current drilling operation the system has the capability of determining the current operation based on access to drilling data and 3rd party data systems. Manual mode may be selected, to where the system recommends the number of generators and the rig crew makes their own determination as to what to switch on and off. System also estimates the current energy usage efficiency between 0-100% based on current loading, generators in use and other drilling factors

Typically rig AC generators never have less than a 0.8 pf rating, so as long as the system Pf control system maintains better than 0.8 then the rig will always be able to utilize 100% of the engine output capacity. It is anticipated that our pf management system will improve the Pf to 0.8 or better. For DC/SCR rigs this is important as the pf often drops below 0.8. On AC/VFD rigs this is not important as the power factor is always close to unity and Pf improvement is not typically required.

The Energy management controller uses the rig operation to provide an initial number of Engines/Gensets required. The system will continuously monitor instantaneous, averaged and historical data points for the Energy store and Engine loading to optimally cycle Engines On and Off line. When the system determines an additional Engine/Gen set is required it will be made available as quickly as possible (i.e. once engine started, warmed, brought on line). During this period of time the system has the ability to provide additional instantaneous and sustained energy via several optional sources such as the Energy store, a flywheel, and/or a Motor/Gen set.

During periods of transient peak power requirements, the system has the ability to provide additional instantaneous and sustained energy via several optional sources such as the Energy store, a flywheel, and/or a Motor/Gen set. During these periods of transient power loading the energy store will discharge to meet requirements and then recharge during lower power requirement periods.

Some rigs may benefit from having engine generators of different KW and KVA sizes. In such an instance, the Energy Management Control System would have the capability to cycle the various generators on and off to optimize fuel usage and overall system efficiency

With specific reference to FIG. 3, as illustrated by the CONFIG INPUT block on the flow chart, the rig configuration is input into the system to define the system model. Specifically, genset specifications, number of gensets and other critical rig specification information. An operator then selects or sets or the rig system senses the rig operation and depth data as indicated at the SELECT block. This can be input directly by an operator or as an automated input from the RIG DATA ACQUISITION AND MODE DETECTION data store. Based on this information, i.e. critical rig data and operation mode, the power requirements are calculated, as indicated at the COMPUTER POWER block. Both the average and maximum power requirements are calculated.

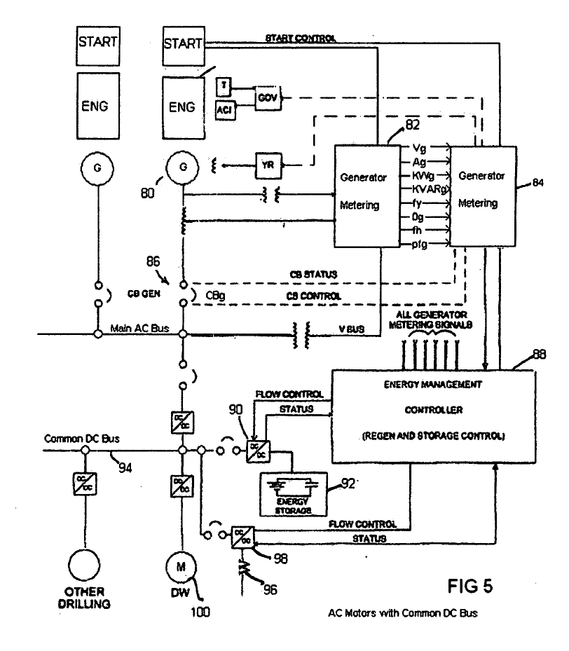

The calculated power requirements are then compared to actual power demand and historical data as indicated at the HISTORY CHECK box. Historical data may include information for the current rig, as well as historical data from other applications and is maintained in the HISTORICAL DATA store. From this calculation the engine requirements, operational requirements and information confirming the number of gensets on line is computed as indicated at the COMPUTE USAGE block. As indicated by the metering systems 82, 84 in FIG. 5, actual generator metering values and generator controller status is read and displayed, as indicated at the METERING block. The current number of recommended engines is also displayed as indicated at the OUTPUT/DISPLAY block and as indicated box 14 of FIGS. 1 and 2. The system is then programmed to run with no change, as indicated the N/C block if the number of operating gensets and the recommended number of gensets match, see boxes 14 and 16 of FIG. 1.

In those cases where the number of recommended gensets do not match the number of operating gensets, the system is instructed as indicated at the AUTO/MAN block to either start additional genset(s), see START ENGINE, or shutdown additional genset(s) SHUTDOWN ENGINE. This may be either an automated function or may be manually controlled, as indicated in the AUTO/MAN block.

As indicated at the COMPUTE STORE MODE block, the appropriate energy store mode and action is computed, wherein the system either charges the storage system, see the CHARGE block and box 27 of FIG. 1 and as indicated at 90 of FIG. 5; discharges energy from the storage system, see the DISCHARGE block and box 27 of FIG. 2 and as indicated at 90 of FIG. 5; runs the genset(s) with power only, see the ENGINE POWER block and as indicated at 84 of FIG. 5; regenerates or brakes the resistor, see the REGENERATE OF RESISTOR BRAKE block, and as indicated at 98 and 102 of FIG. 5; and makes a power factor correction, see the Pf CORRECTION block. The regeneration status is also monitored and displayed, as indicated at the REGENERATION STATUS block.

This operating information is then looped back to the SELECT block, see the LOOP block, whereby the system is continually updated and the process is repeated.

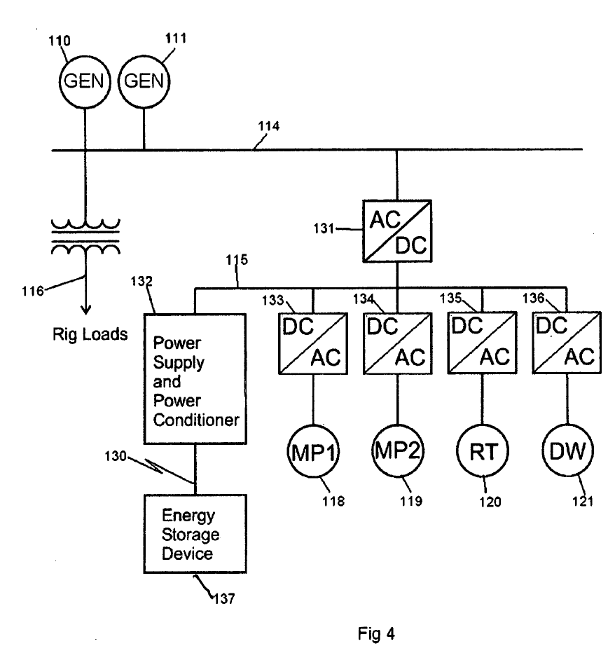

As shown in FIG. 4, the storage/source system 30 of the subject invention comprises a power supply and power conditioner unit 32 and an energy storage device 37. A typical power supply and power conditioner unit 32 similar to a Siemens Sibac energy storage system and an Elspec Equalizer system with advanced power. A typical energy storage device is deep cycle lead acid batteries, available from Axion Power, Trojan, US Battery, and Exide, by way of example.

The controller system is an integral component of the power supply and power conditioner 32 and monitors load, energy storage, state of charge, and other information in order to determine how many generators to run, when to start/stop generators, and other typical functions. A block circuit diagram for this configuration is shown in FIG. 5.

The energy demand remains within the capacity of the first generator 10 in block B, as indicated by the line segment 60. As indicated in block C, when the energy demand exceeds the capacity of generator 10, energy is supplied by generator 11, see line segment 62 and the areas under this line segment indicated by 64 and 65. During this mode of operation, all of the capacity of generator 10 is being used by the rig loads and motors, with the excess capacity of generator 11 being stored in the energy storage device of the subject invention. As indicated by block D, this continues during any operational mode where the capacity of generator 10 is exceeded but the power requirements are less than the combined capacity of generators 10 and 11.

During peak demand periods as indicated in block E, when the demand exceeds the combined capacity of both generators 10 and 11, as indicated at area 66, the excess energy demands are met by withdrawing stored energy from the energy storage device of the subject invention.

The various symbols relevant to FIG. 5 are as follows:
AC/DC Alternating Current to Direct Current Conversion
Act Actuator
A_{g} Amps—Generator
b Bus
CB Circuit Breaker
CB_{g} Circuit Breaker—Generator
CT Current Transformer
DC/DC Direct Current to Direct Current Conversion
DW Drawworks
Eng Engine—Prime Mover
f_{b} Frequency—Bus
f_{g} Frequency—Generator
pf_{b} Power Factor—Bus
pf_{g} Power Factor—Generator
g Generator
G Generator
Gov Governor
KVAR_{g} KiloVars—Generator
KW_{g} KiloWatts—Generator
M Motor
Ø_{g} Phase—Generator
pf Power Factor
PT Potential Transformer
Start Starting Unit for Prime Mover
T Tachometer
V_{b} Voltage—Bus
V_{g} Voltage—Generator
VR Voltage Regulator

With specific reference to FIG. 8, the controller system there shown is adapted for a rig system having AC drives with a common DC bus, similar to that sown in FIG. 2. It should be understand that any number of permutations of configurations may be utilized without departing from the scope and spirit of the invention. The configuration of FIG. 8 is merely an example of a rig configuration and should not be considered limiting in any manner. With specific reference to FIG. 8, the following signals are generated for each engine (Eng) 79 and generator (G) 80 set: Volts (Vg), Amps (Ag), Kilowatts (KW), KiloVars (Kvar), Power Factor (pf_{g}), Frequency Generator (f_{g}), Volts Bus (V_{b}), Frequency Bus (f_{b}) and Phase Reference (Ø_{g}) (Ø_{b}) for synchronizing the generators (G). This permits comprehensive metering of the generator, as indicated at generator metering block 82.

The generator controller 84 receives inputs from the generator metering block 82, from the circuit breaker (CB_{g}) 86 and from the energy management controller 88. The generator controller 84 is responsible for auto starting and auto stopping of engines, for synchronizing generators and for auto closure/opening of the generator circuit breaker (CB_{g}) 86.

The energy storage converter 90 consists of a bidirectional DC to DC converter. Based upon commands from the energy management controller 88 it will charge the energy storage devices 92 or it will provide energy back to the main DC bus 94. The converter 90 also monitors the amount of energy currently stored and the overall health of the storage devices 92. If storage capacity exists, the management controller 88 will throttle back on the energy dissipated in a resistor bank 96 via the dynamic braking chopper 98 and will convert it to stored energy in the energy storage devices 92. The energy storage device(s) may consist of, but is not limited to, a system of batteries, capacitors, ultracapacitors, flywheels, or combinations thereof. The dynamic chopper 98 typically exists on AC style drawworks for dissipation of energy into the resistor bank 96. The drawworks resistor bank 96 is utilized to convert mechanical energy from the drawworks motor 100 into heat energy.

The energy management controller 88 is responsible for controlling how much energy will be stored and when engines need to be switched on or off. This controller receives the generator metering information from each generator metering block 82, circuit breaker 86 and engine status from the generator controller 84. It also receives energy storage status from the energy storage converter 90, regenerative energy status from the energy storage converter 90 and the DW dynamic braking chopper 98. Based on rig drilling requirements this controller will provide outputs to the energy storage converter 90 to store excess generated energy. Once the stores are charged, if rig demand allow, generators will automatically be switched off to conserve fuel usage. Once the energy stores are utilized and/or rig demands require additional capacity this controller 88 will signal the generator controller 84 to bring online additional capacity.

The energy storage system may comprise any of a variety of storage devices, including, but not limited to: lead acid batteries, ultra-capacitors, hybrid battery/super-capacitors, Nickel Metal Hydride batteries, Lithium Ion batteries, and flow batteries, and flywheels. Specifically, the energy storage device comprises a system for reversibly storing electrical energy.

The subject invention greatly enhances the efficiency of the entire system by permitting selective use of the available generators on an as necessary basis and by permitting operating generators to run at close to maximum efficiency by storing rather than dissipating excess energy and by utilizing stored energy during peak demand. This system permits each generator to operate at high efficiency as well as preserving excess energy generated during operation.

While certain features and embodiments of the invention have been described in detail herein, it should be understood that the invention encompasses all modifications and enhancements within the scope and spirit of the accompanying claims.

What is claimed is:

1. A method for managing an energy supply and storage system for a rig power supply of the type comprising a power generator coupled to rig loads, the power generator used for powering the rig and for charging the storage system, and the storage system adapted for selectively supplementing rig power, the method comprising the steps of:
a. Selecting a rig function operation;
b. Setting the system to recommended settings for the selected rig function operation;
c. Monitoring rig power usage for the selected rig function operation;
d. Distributing excess power to the storage system when the rig power usage falls below a preselected threshold;
e. Distributing stored power from the storage system when the rig power usage is above a preselected threshold.

2. The method of claim 1, further including modifying the recommended setting for the selected rig function when the rig power usage is above a preselected threshold.

3. The method of claim 1 wherein the rig includes a plurality of engines for providing power to the rig and wherein the setting step comprises the step of activating and running selected engines.

4. The method of claim 1, wherein steps b-e are activated automatically depending upon the rig operation function.

5. The method of claim 1, wherein steps b-e are activated manually.

6. The method of claim 1, the energy supply and storage system comprising:
a. a power supply in parallel with the rig motors and adapted for receiving energy generated by the generator in excess of demand; and
b. an energy storage system in communication with the power supply for receiving and storing the excess energy, the power supply being adapted to draw energy from the storage system when the rig motor demand exceeds the capacity of the generator.

7. The method of claim 1, including the step of conditioning the energy stored in and withdrawn from the energy storage system.

8. The method of claim 1, wherein the energy storage system comprises lead acid batteries.

9. The method of claim 1, wherein the energy storage device comprises ultra-capacitors.

10. The method of claim 1, wherein the energy storage device comprises hybrid battery/super-capacitors.

11. The method of claim 1, wherein the energy storage device comprises Nickel Metal Hydride batteries.

12. The method of claim 1, wherein the energy storage device comprises Lithium Ion batteries.

13. The method of claim 1, wherein the energy storage device comprises flow batteries.

14. The method of claim 1, wherein the energy storage device comprises a system for reversibly storing electrical energy.

15. The method of claim 1, wherein the energy storage device comprises fly wheels.

16. The method of claim 1, wherein the rig loads are in parallel with the power supply and storage system.

17. The method of claim 1 further including a braking resistor.

18. A method for managing an energy supply system for a rig power supply of the type comprising a power generator coupled to rig loads, the power generator used for powering the rig, the method comprising the steps of:
a. Selecting a rig function operation;
b. Setting the system to recommended settings for the selected rig function operation;
c. Monitoring rig power usage for the selected rig function operation;
d. Managing the output of the power generator based on rig power usage wherein the output is increased when the rig power requirements are above a preselected threshold and wherein the output is decreased when the rig power requirements fall below a preselected threshold.

19. The method of claim 19, further including an energy storage system associated with the energy supply system and including the steps of:
a. drawing energy from the storage system in periods of high power requirements;
b. distributing excess energy to the storage system in periods of low power requirements.
